(19) United States
(12) Patent Application Publication
(10) Pub. No.: US 2016/0010630 A1
(43) Pub. Date: Jan. 14, 2016

(54) ISAAKIDIS THERMAL ENGINEERED SYSTEMS

(71) Applicant: Ignatious ISAAKIDIS, Victoria (AU)

(72) Inventor: Ignatious ISAAKIDIS, Doncaster East (AU)

(21) Appl. No.: 14/765,417

(22) PCT Filed: Feb. 3, 2014
(86) PCT No.: PCT/AU2014/000074

§ 371 Date: Aug. 3, 2015

(30) Foreign Application Priority Data
Feb. 3, 2013 (AU) 2013200620

(51) Int. Cl. F03G 7/04

(52) U.S. Cl. CPC F03G 7/04

(57) ABSTRACT

A thermal energy harnessing system which comprises of an energy harnessing chamber system with a return outlet pressurised pipe/chamber system that provides a safer and controlled way of absorbing, extracting, conducting and harnessing thermal energy by transferring the thermal energy to gasses, liquids or any other material within an energy harnessing chamber(s). Valves connect and create chamber(s). Valves are triggered at predetermined settings to control temperature, pressure, volume and duration of gases, liquids or other material(s) within the chamber(s). The heated pressurised gases, liquids or other material can be transferred to the return outlet pressurised pipe chamber(s) and to any location and/or an energy converting plant through the return outlet pressurised pipe chamber(s). Thus energy from thermal heat can be transferred from chamber to chamber to any location without the need of pumps.

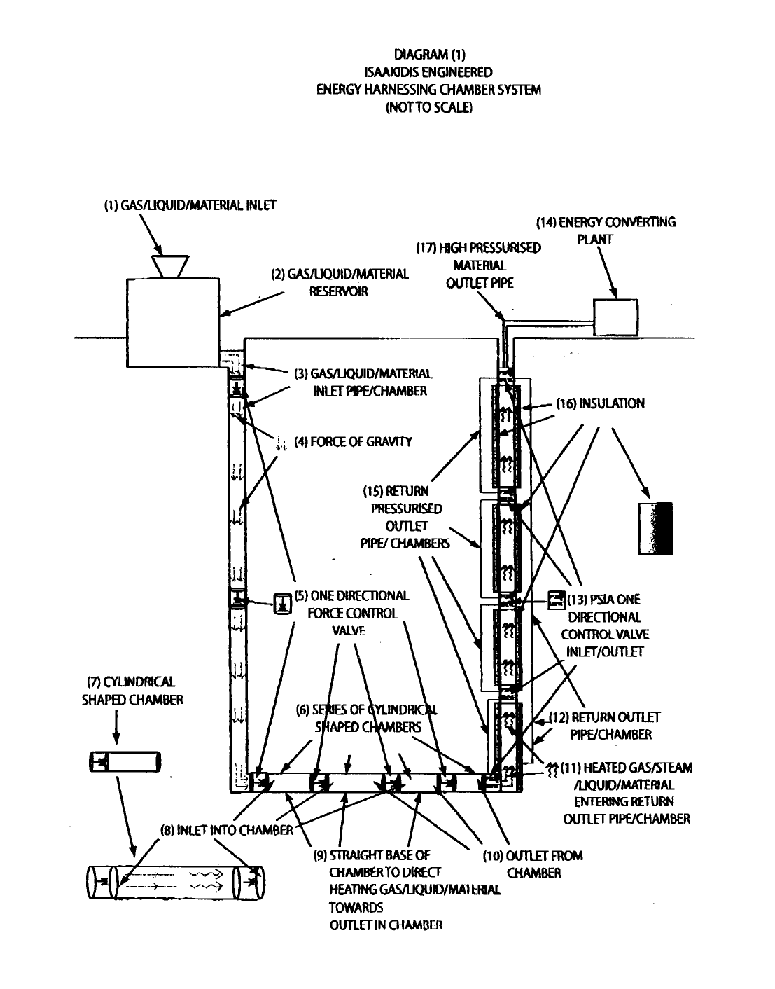

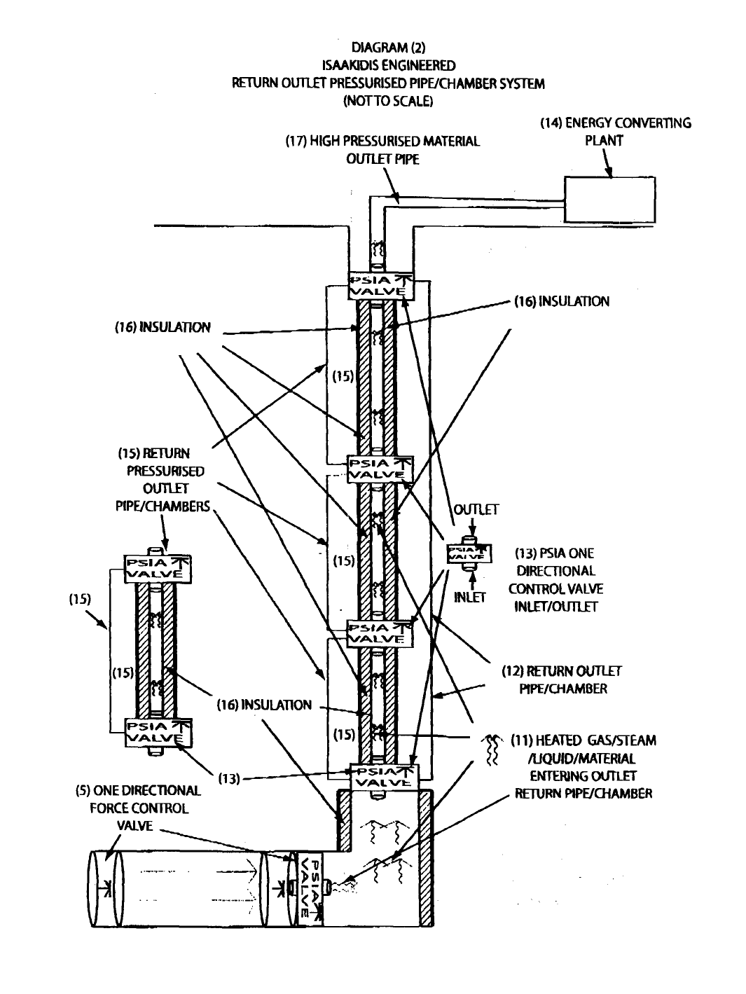

### CROSS REFERENCE TO RELATED APPLICATIONS

This application is a U.S. National Phase Application under 35 U.S.C. 371 of International Application No. PCT/AU2014/000074 filed on Feb. 3, 2014 and published as WO 2014/117224 A1 on Aug. 8, 2014. This application is based on and claims the benefit of priority from Australian Application No. 2013200620 filed on Feb. 3, 2013. The entire disclosures of all of the above applications are incorporated herein by reference.

### FIELD OF THE INVENTION

1. This invention relates to inventive steps and improvements in extracting, transferring and harnessing heat from any reliable heat source. The ISAAKIDIS THERMAL ENGINEERED SYSTEMS provide a safe alternate controlled way of trapping heat energy that can convert and control the temperature and pressure into different phases of heated material in a chamber. The invention relates to methods and devices capable of transferring and transmuting material and pressure to a location where it may be used for a multitude of purposes such as generating electricity and other multi purpose utilities and variable applications. The invention includes inventive steps for harnessing, transferring and use of energy from thermal energy.

### BACKGROUND TO THE INVENTION AND RELATED ART

Every day heat is used as Energy. There are many conventional ways heat energy can be extracted from man made heat sources or natural occurring heat sources. Geothermal is a natural occurring heat source, whereas man made heat sources such as nuclear, fossil fuels are some resources used to extract, created heat energy. Geothermal energy has been used for household heating and low power generation. This is largely due the lack of innovative devices and methods to extract, transfer and harness the thermal energy in the most effective way. Ground source heat exchange and extraction systems are generally inadequate and unable to harness thermal geothermal energy to its maximum potential. The conventional methods include:
2. Pumping cold water into the earth's interior through “geothermal wells” or “geothermal boreholes” or “hot dry rock reservoirs”. The hot water is then pumped to the surface and used conventionally for household heating or creating small quantities of electricity such as described in U.S. Pat. No. 6,668,554 B1 (Brown) 30 Dec. 2003 (D2); U.S. Pat. No. 3,786,858 (Potter) 22 Jan. 1974. The limitations of these inventions are that the liquids pumped into boreholes evaporate when making contact with the earth's interior. There is no control mechanism in the earth's interior to extract the geothermal heat and fails thereby to fully harness the geothermal heat to be transferred to the earth's surface. There is a need to extract the green energy and transfer material into the earth's interior without the use of pumps. There is a need to use controlled devices such as larger pipes and effective chambers using specially designed one directional valves to prevent contamination and to allow the material to be transferred in various stages in controlled phases until there is optimal heat exchange or transfer to the earth's surface without the use of pumps.
3. Other existing devices such as manifolds located on or close to the earth's surface to control flow rate are incapable of controlling the flow and heat in the earth's interior. There is a need for the use of suitable devices (rather than flexible plastic pipes) and need for safer material rather than liquids such as antifreeze or supercritical fluids, which are unable to withstand the extreme geothermal heat in the earth's interior. There is a need therefore for suitable material that can withstand extreme heat and pressure as well as control valves beneath the earth's surface that can be independently or remotely controlled. Such remotely controlled valves at various locations within the earth's interior would enable material to be geothermally heated until the maximum temperature and pressure has been achieved.
4. Existing inventions rely on the use of pumps to either pump or inject liquids to thermal heat sources. This requires the use of additional energy and in the case of loss of power or an emergency, these inventions would fail. There is a need therefore for a safer, easier and controlled way of extracting, trapping and transferring heat energy without the need for pumps.

With the effects of global warming, nuclear risks and carbon emissions, there is a need to find alternate power extraction and more efficient methods and devices to harness thermal energy on a large scale. This invention can harness and extract heat from any reliable heat energy source in constant supply, man made or natural heat source, to be utilised for a number of uses such as:
a) Providing low clean energy and renewable energy;
b) Ways to generate electricity;
c) Providing low cost large amounts of reliable power;
d) To refine/extract oil using heated material for the petroleum industry or refine/extract any other materials or any other industry;
e) Creating steam and other material to refine oil;
f) Creating cleaner energy;
g) Creating steam and other material to produce linear or rotary motion;
h) Creating gas pressure to produce linear or rotary motion;
i) Creating hydraulic pressure to produce linear or rotary motion;
j) Creating pneumatic pressure to produce linear or rotary motion;
k) Creating energy or gas pressure for usage on small or large scale
l) Creating cyclic compression and expansion of air or other gases and providing a medium at varying temperature levels to enable the conversion of heat energy to mechanical work;
m) Cooling or heating without the use of pumps;
n) From any reliable heat energy source extracting, transferring, harnessing and exchanging heat without causing pollution.

The existing uses of geothermal energy have a limited use in that they have been used for the conventional use of household heating and low power generation.

Nuclear power although in use in many countries has been proven to be risky if loss of power in the event of an emergency which this invention can over come.

With rise in price of oil and fossil fuels emission pricing and worlds needs for more energy.

There is therefore a need for devices that are capable of harnessing thermal energy more cost effective to be utilised for multiple purposes. This invention relates to innovative design of devices to safely harness heat energy or thermal energy from any reliable heat source. More importantly, this invention provides an alternate controlled way to extract and transfer energy.

### SUMMARY OF THE INVENTIONS

The present invention comprising of the ISAAKIDIS THERMAL ENGINEERED SYSTEMS include two types of devices that may be installed at any reliable thermal heat source. The invention includes:
1. ISAAKIDIS ENGINEERED ENERGY HARNESSING CHAMBER SYSTEM.
2. ISAAKIDIS ENGINEERED RETURN OUTLET PRESSURISED PIPE/CHAMBER SYSTEM.

### PREFERRED ASPECTS OF THE INVENTIONS

This invention relates to inventive steps and improvements in extracting, transferring and harnessing heat from any reliable heat source. The ISAAKIDIS ENGINEERED ENERGY HARNESSING CHAMBER SYSTEM can enable gases, liquids, heated material or other material to be conveyed to and from any reliable heat source. The inventions provide for the energy harnessing chamber system to be interchangeable and enables the energy harnessing chamber system to operate either independently, or in series, or in parallel, or any parallel combination, or as interchangeable or in a combination of the energy harnessing chamber system(s) through a hybrid structure whereby the system(s) are used to harness thermal heat energy. The ISAAKIDIS ENGINEERED RETURN OUTLET PRESSURISED PIPE/CHAMBER SYSTEM enables harnessed/trapped energy, gases, pressure and heated material to be conveyed or expelled to a location. The heated material may be used for any purpose at a location and may be recirculated and recycled to the Inlet Pipe/Chamber or energy harnessing chamber, back to the energy harnessing chamber system. The two systems are described in detail below.

### BRIEF DESCRIPTION OF THE DIAGRAMS

The two different diagrams represent:
1. ISAAKIDIS ENGINEERED ENERGY HARNESSING CHAMBER SYSTEM.
2. ISAAKIDIS ENGINEERED RETURN OUTLET PRESSURISED PIPE/CHAMBER SYSTEM.

From the two different diagrams the first depicts the ENERGY HARNESSING CHAMBER SYSTEM and the second diagram depicts the RETURN OUTLET PRESSURISED PIPE/CHAMBER SYSTEM that would channel energy, gases, pressure and other material from any reliable thermal energy harnessing or producing devices to a location to be utilised for a multitude of uses.

Diagram 1 is a cross sectional view of the ENERGY HARNESSING CHAMBER SYSTEM of the ISAAKIDIS THERMAL ENGINEERED SYSTEMS in accordance with this invention.

Diagram 2 is a cross sectional view of the RETURN OUTLET PRESSURISED PIPE/CHAMBER SYSTEM of the ISAAKIDIS THERMAL ENGINEERED SYSTEMS.

### INTEGER LIST

Diagram 1

Diagram 1 is a cross sectional view of the ENERGY HARNESSING CHAMBER SYSTEM in accordance with this invention.

Diagram 1
1. Gas, Liquid/Material inlet.
2. Gas/Liquid/Material reservoir.
3. Gas/Liquid/Material inlet PIPE/CHAMBER.
4. Force of gravity.
5. One directional force control valve.
6. Series of cylindrical shaped chambers.
7. Cylindrical shaped chamber/(single energy harnessing chamber).
8. Inlet into chamber.
9. Straight base of chamber to direct heating gas/liquid/material towards outlet in chamber.
10. Outlet from chamber.
11. Heated gas/steam/liquid/material entering return outlet PIPE/CHAMBER.
12. Return Outlet PIPE/CHAMBER.
13. PSIA one directional control valve Inlet/Outlet.
14. Energy converting plant.
15. Return Pressurised Outlet Pipe/Chambers.
16. Insulation.
17. High Pressurised Material Outlet Pipe.

Diagram 2

Diagram 2 is a cross sectional view of the RETURN OUTLET PRESSURISED PIPE/CHAMBER SYSTEM.

Diagram 2
11. Heated gas/steam/liquid/material entering outlet return PIPE/CHAMBER.
12. Return Outlet PIPE/CHAMBER.
13. PSIA one directional control valve inlet/outlet.
14. Energy converting plant.
15. Return Pressurised Outlet Pipe/Chambers.
16. Insulation.
17. High Pressurised Material Outlet Pipe.

### DETAILED DESCRIPTION WITH RESPECT TO THE TWO DIAGRAMS

### A:—Energy Harnessing Chamber System

Diagram 1:

Diagram 1 is a cross sectional view of the ENERGY HARNESSING CHAMBER SYSTEM in accordance with this invention showing a three dimensional view.

Diagram 1
1. Gas/Liquid/Material inlet.
2. Gas/Liquid/Material reservoir.
3. Gas/Liquid/Material inlet PIPE/CHAMBER.
4. Force of gravity.
5. One directional Force control valve.
6. Series of cylindrical shaped chambers.
7. Cylindrical shaped chamber/(single energy harnessing chamber).
8. Inlet into chamber.
9. Straight base of chamber to direct heating gas/liquid/material towards outlet in chamber.
10. Outlet from chamber.
11. Heated gas/steam/liquid/material entering return outlet PIPE/CHAMBER.
12. Return Outlet PIPE/CHAMBER.
13. PSIA one directional control valve Inlet/Outlet.
14. Energy converting plant.
15. Return Pressurised Outlet Pipe/Chambers.
16. Insulation.
17. High Pressurised Material Outlet Pipe.

1. Gas/Liquid/Material Inlet.

The inlet is an opening that allows for gases, liquids or any other material to be conveyed and directed into the reservoir.

2. Gas/Liquid/Material Reservoir.

The reservoir provides a storage facility for the gas, liquids or any other material. The reservoir may be erected above any energy harnessing chamber. The reservoir may be built using material suitable to meet prevailing conditions such as withstand corrosion, high temperature or high pressure including conditions of environment and for safe storage depending on the type of material to be stored therein.

3. Gas/Liquid/Material Inlet PIPE/CHAMBER.

The inlet PIPE/CHAMBER may be constructed using material suitable for the safe passage of the gas, liquids or any other material. The inlet PIPE/CHAMBER will provide for the downward passage of the gas, liquids or any other material assisted by the force of gravity. The inlet PIPE/CHAMBER connects the reservoir to the single energy harnessing chamber. The inlet PIPE/CHAMBER will convey the gases, liquids or other material in their natural state to the energy harnessing chamber prior to the application of thermal energy harnessed in the chamber.

4. Force of Gravity.

The Force of gravity is created in the inlet PIPE/CHAMBER connecting the reservoir to the energy harnessing chamber. The energy harnessing chamber is constructed at any reliable thermal heat source below the reservoir and inlet PIPE/CHAMBER. This allows for the natural downward passage for liquids or other materials to enter the energy harnessing chamber assisted by the force of gravity. This obviates the need to have liquids or other material pumped into the energy harnessing chamber. A pump may be used to accelerate the rate of transport of material. In the case of gases, original pressure from the reservoir or inlet would apply to flow and direct the gas to the inlet PIPE/CHAMBER.

5. One Directional Force Control Valve.

The one directional force control valve is a one way valve permitting gases, liquids or other material to flow in one direction only. The force of gravity allows the material in the inlet PIPE/CHAMBER to be conveyed to the energy harnessing chamber. The valves prevent the gases, liquids or other material from returning in the opposite direction. The one directional force control valve enables the material in the inlet PIPE/CHAMBER or in the energy harnessing chambers to be conveyed in the direction as required to and through the inlet PIPE/CHAMBER and/or energy harnessing chamber.

The valve is controlled to either let material enter or leave and enables the control of the volume of material entering and leaving each section of the inlet PIPE/CHAMBER and/or the energy harnessing chambers. The control valve may be used to control the speed and velocity of the material travelling through the inlet PIPE/CHAMBER or the energy harnessing chambers. The control valve allows for the regulation of the passage of material entering the energy harnessing chambers when leaving the inlet PIPE/CHAMBER. The control valve may be used to shut off or reduce supply in the inlet PIPE/CHAMBER or in the energy harnessing chambers in the event of an emergency or during maintenance works.

6. Series of Cylindrical Shaped Chambers.

The series of cylindrical shaped chambers connect a series of individual chambers to each other the chambers can have any shape, and can be connected in series or any parallel, or any series and parallels combination. The series of chambers connect the inlet pipe/chamber to the outlet pipe/chamber providing a medium wherein thermal energy may be harnessed. One directional force control valves separate each chamber in the series of chambers. The one directional force control valve enables the gases, liquids or other material to be conveyed in one direction only.

The force of gravity and the pressure assists the material in the chamber to be conveyed in the energy harnessing chamber towards the outlet in each chamber. The valves allow the material in each chamber to pass in one direction as required namely from the Inlet into chamber towards the Outlet from chamber. The one directional control valves prevent the gases, liquids or other material from returning in the opposite direction (backwards) towards the inlet into each chamber.

The control valve enables the control of the volume of material entering and leaving each chamber. The valve may be used to control the speed and velocity of the material travelling through each chamber. The valve allows for the regulation of the passage of material entering the energy harnessing chamber, remaining in each chamber and when leaving the chamber. The valve may be used to shut off or reduce supply in the chamber in the event of an emergency or during maintenance works.

7. Cylindrical Shaped Chamber.

The cylindrical shaped chamber which can have any shape and be made of suitable material capable of conveying gases, liquids or any other material through each chamber that can conduct heat and provide resistance to prevailing conditions such as withstand corrosion, high temperature or high pressure including conditions of environment. The cylindrical shaped chamber should be located near a reliable heat source. Each chamber has an inlet for entry of material and an outlet for material to exit. There is a one directional control valve at the Inlet into chamber and another one directional force valve at the Outlet from chamber. The gas, liquids or other material enters the chamber through the inlet. The material in the chamber begins to heat through the chamber walls due to exposure to thermal heat. The chamber thereby harnesses the thermal energy and can convert the material in the chamber into gas and pressure. The converted gas and pressure leave the chamber and enter the next chamber where the process is repeated and the thermal energy is increased. The chambers are interconnected such that by the time the thermal energy is about to leave the last chamber, it is sufficiently harnessed before it enters the outlet pipe/chamber connected to the last chamber in the series of chambers.

8. Inlet into Chamber.

The Inlet into chamber is the entry point for the gas, liquids or other material that enters the cylindrical shaped chamber. There is a one directional force control valve at the entry into the cylindrical shaped chamber. The one directional control valve can allow the controlled movement of gas, liquids and other material to enter through the Inlet into cylindrical shaped chamber thereby controlling the volume, velocity, pressure, direction, temperature, speed and duration of the gas, liquids and other material remaining in each chamber. The valves at each Inlet into chamber prevent the gas, liquids and other materials from moving backwards into the inlet pipe/chamber or any of the energy harnessing chambers that are before the Inlet into Chamber. The Inlet into chamber assisted by the valves allows the gases, liquids or other material to travel in one direction (forward) in each energy harnessing chamber.

9. Straight Base of Chamber to Direct Heating Gas/Liquid/Material Towards Outlet in Chamber.

The Straight base of Chamber conducts thermal energy to gases, liquids or any other material within the chamber through the chamber walls to transmute the material in the chamber and to flow and channel through to and out the Outlet of the Chamber. The Straight base of Chamber can have any shape including spiral shapes, and can be connected in series or any parallel or any series and parallels combination.

10. Outlet from Chamber.

The Outlet from Chamber is the exit point for the gas, liquids or other material that leaves the cylindrical shaped chamber. There is a one directional force control valve at the Outlet from the cylindrical shaped chamber. The one directional control valve can allow the controlled movement of gas, liquids and other material to leave through the Outlet from the cylindrical shaped chamber thereby controlling the volume, velocity, pressure, direction, temperature, speed and duration of the gases, liquids or other material remaining in each chamber. The valves at each Outlet from Chamber allow and control the pressure, volume, direction, duration, temperature and flow of the gases, liquids or other materials exiting the chamber thereby controlling the duration that the material in the chamber require to be subjected to the thermal energy. The Outlet from Chamber assisted by the valves allows the gases, liquids or other material to travel in one direction (forward) into the next energy harnessing chamber.

11. Heated Gas/Steam/Liquid/Material Entering Return Outlet PIPE/CHAMBER.

The gases, liquid(s) or other material that had been subjected to the energy harnessing chambers would be directed into the Return outlet PIPE/CHAMBER on leaving the last energy harnessing chamber. The temperature, volume and pressure is at their highest at this point of entry into the outlet return pipe. The thermal heat temperature causes the pressure and volume of the gas to expand and to look for an escape route towards the PSIA one directional control valve.

12 Return Outlet PIPE/CHAMBER.

The Return Outlet Pipe/Chamber can connect the single energy harnessing chambers to an Energy Harnessing Plant. The Return Outlet Pipe/Chamber provides a passage to convey heated material, pressure and gas. The Return Outlet Pipe/Chamber is made of suitable material capable to convey gases, liquids, heated material or any other material for the safe passage thereof and can provide resistance to prevailing conditions such as withstand corrosion, high temperature or high pressure including conditions of environment.

13. PSIA One Directional Control Valve Inlet/Outlet.

The PSIA (absolute pressure of the substance which would then include the atmospheric pressure) one directional control valve may be controlled to either let material enter or leave the return outlet pipe/chamber. PSIA is an abbreviation to indicate to a person skilled in the art; at that part of the system high pressure is present, one of the prevailing conditions acting upon the valve will be high pressures. High pressure will need to be considered when choosing the one way valves at this section of the system.

The PSIA one directional control valve is a one way valve permitting gases, liquids or other material to flow in one direction only. The force of pressure allows the material in the return outlet pipe/chamber to be conveyed to the energy converting plant. The one directional PSIA valves prevent the gases, liquids or other material from returning in the opposite direction, only towards an energy converting plant. The one directional PSIA valve enables the material in the return outlet pipe/chamber to be conveyed in the direction as required.

The PSIA valve enables the control and regulation of the pressure entering and leaving each section of the return outlet pipe/chamber. The PSIA valve may be used to control the volume of the material travelling through the return outlet pipe/chamber. The PSIA valve can allow for the regulation of the pressure, temperature and volume of material entering and leaving the return outlet pipe/chamber. The control valve may be used to shut off or reduce pressure or supply of material in the return outlet pipe/chamber in the event of an emergency or during maintenance works.

The PSIA valve can control the volume, velocity, pressure, direction, duration, temperature and speed of the material entering or leaving a chamber.

14. Energy Converting Plant.

The Energy Converting Plant is located at a near location. The energy conveyed to the energy converting plant can or may be utilised for a multitude of purposes including:
a) Generating electricity;
b) Using heated gases/steam/liquid/or any other material in the process to refine oil in the petroleum industry or refine any other material;
c) Creating steam and other material to produce linear or rotary motion;
d) Creating gas pressure to produce linear or rotary motion;
e) Creating hydraulic pressure to produce linear or rotary motion;
f) Creating pneumatic pressure to produce linear or rotary motion;
g) Creating energy or gas pressure for usage on small or large scale.

15. Return Pressurised Outlet Pipe/Chambers.

The Return outlet pipe/chamber has inlet/outlet PSIA valves at intervals. These valves separate and create a series of return pressurised outlet pipe/chambers within the return outlet pipe/chamber. Each return pressurised outlet pipe/chamber has inlet/outlet PSIA valves on both sides. A series of these return pressurised outlet pipe/chambers form the return outlet pipe/chamber.

The pressurised gas/steam/liquid or any other material would enter the return pressurised outlet pipe/chamber through the PSIA valve acting as an inlet valve and remains in the return pressurised outlet chamber. The inlet PSIA valve controls and regulates the volume, temperature and pressure of the material entering the chamber. The constant flow of the material creates an increased pressure in the chamber. The outlet PSIA valve at the other end of the chamber would control and regulate the volume, temperature and pressure of the material leaving the chamber.

The material on leaving the chamber would immediately enter the next chamber through the same PSIA valve, which now acts as an inlet PSIA valve at the entry point of the adjacent chamber. The PSIA valves acting as inlet or outlet valves connect each chamber. The process is repeated in each chamber. The material is thus conveyed using the regulating PSIA valves and harnessed energy.

16. Insulation.

The insulation may be made of any material capable of retaining heat in the Return Outlet Pipe/Chamber and High Pressurised Material Outlet Pipe.

17. High Pressurised Material Outlet Pipe.

The High Pressure Material Outlet Pipe connects and transfers material from the Return Outlet Pipe/Chamber to the Energy Harnessing Plant. This Pipe can be made of suitable material capable to convey gases, liquids, heated material or any other material for the safe passage thereof, and can provide resistance to prevailing conditions such as withstand corrosion, high temperature or high pressure including conditions of environment to transfer the heated material for any use. The said high pressurised material outlet pipe can have a reducing diameter so as to retain pressure.

### B:—Return Outlet Pressurised Pipe/Chamber System

Diagram 2:

Diagram 2 is a cross sectional view of the RETURN OUTLET PRESSURISED PIPE/CHAMBER SYSTEM in accordance with this invention showing three-dimensional view.

Diagram 2
11. Heated gas/steam/liquid/material entering outlet return PIPE/CHAMBER.
12. Return Outlet PIPE/CHAMBER.
13. PSIA one directional control valve Inlet/Outlet.
14. Energy converting plant.
15. Return Pressurised Outlet Chambers.
16. Insulation.
17. High Pressurised Material Outlet Pipe.

11. Heated Gas/Steam/Liquid/Material Entering Return Outlet PIPE/CHAMBER.

The gases, liquid(s) or other material that had been subjected to the energy harnessing chambers would be directed into the Return outlet PIPE/CHAMBER on leaving the last energy harnessing chamber. The temperature, volume and pressure is at their highest at this point of entry into the outlet return pipe. The thermal heat temperature causes the pressure and volume of the gas to expand and to look for an escape route towards the PSIA one directional control valve.

12 Return Outlet PIPE/CHAMBER.

The Return Outlet Pipe/Chamber can connect the single energy harnessing chambers to an Energy Harnessing Plant. The Return Outlet Pipe/Chamber provides a passage to convey heated material, pressure and gas. The Return Outlet Pipe/Chamber is made of suitable material able to convey gases, liquids, heated material or any other material for the safe passage thereof and can provide resistance to prevailing conditions such as withstand corrosion, high temperature or high pressure including conditions of environment.

13. PSIA One Directional Control Valve Inlet/Outlet.

The PSIA (absolute pressure of the substance which would then include the atmospheric pressure) one directional control valve may be controlled to either let material enter or leave the return outlet pipe/chamber. PSIA is an abbreviation to indicate to a person skilled in the art; at that part of the system high pressure is present, one of the prevailing conditions acting upon the valve will be high pressures. High pressure will need to be considered when choosing the one way valves at this section of the system.

The PSIA one directional control valve is a one way valve permitting gases, liquids or other material to flow in one direction only. The force of pressure allows the material in the return outlet pipe/chamber to be conveyed to the energy converting plant. The one directional PSIA valves prevent the gases, liquids or other material from returning in the opposite direction, only towards an energy converting plant. The one directional PSIA valve enables the material in the return outlet pipe/chamber to be conveyed in the direction as required.

The PSIA valve enables the control and regulation of the pressure entering and leaving each section of the return outlet pipe/chamber. The PSIA valve may be used to control the volume of the material travelling through the return outlet pipe/chamber. The PSIA valve can allow for the regulation of the pressure, temperature and volume of material entering and leaving the return outlet pipe/chamber. The control valve may be used to shut off or reduce pressure or supply of material in the return outlet pipe/chamber in the event of an emergency or during maintenance works.

The PSIA valve can control the volume, velocity, pressure, direction, duration, temperature and speed of the material entering or leaving a chamber.

14. Energy Converting Plant.

The Energy Converting Plant is located at a near location. The energy conveyed to the energy converting plant can or may be utilised for a multitude of purposes including:
a) Generating electricity;
b) Using heated gases/steam/liquid/or any other material in the process to refine oil in the petroleum industry or refine any other material;
c) Creating steam and other material to produce linear or rotary motion;
d) Creating gas pressure to produce linear or rotary motion;
e) Creating hydraulic pressure to produce linear or rotary motion;
f) Creating pneumatic pressure to produce linear or rotary motion;
g) Creating energy or gas pressure for usage on small or large scale.

15. Return Pressurised Outlet Pipe/Chambers.

The Return outlet pipe/chamber has inlet/outlet PSIA valves at intervals. These valves separate and create a series of return pressurised outlet pipe/chambers within the return outlet pipe/chamber. Each return pressurised outlet pipe/chamber has inlet/outlet PSIA valves on both sides. A series of these return pressurised outlet pipe/chambers form the return outlet pipe/chamber.

The pressurised gas/steam/liquid or any other material would enter the return pressurised outlet pipe/chamber through the PSIA valve acting as an inlet valve and remains in the return pressurised outlet chamber. The inlet PSIA valve controls and regulates the volume, temperature and pressure of the material entering the chamber. The constant flow of the material creates an increased pressure in the chamber. The outlet PSIA valve at the other end of the chamber would control and regulate the volume, temperature and pressure of the material leaving the chamber.

The material on leaving the chamber would immediately enter the next chamber through the same PSIA valve, which now acts as an inlet PSIA valve at the entry point of the adjacent chamber. The PSIA valves acting as inlet or outlet valves connect each chamber. The process is repeated in each chamber. The material is thus conveyed using the regulating PSIA valves and harnessed energy.

16. Insulation.

The insulation may be made of any material capable of retaining heat in the Return Outlet Pipe/Chamber and High Pressurised Material Outlet Pipe.

17. High Pressurised Material Outlet Pipe.

The High Pressure Material Outlet Pipe connects and transfers material from the Return Outlet Pipe/Chamber to the Energy Harnessing Plant. This Pipe can be made of suitable material capable to convey gases, liquids, heated material or any other material for the safe passage thereof, and can provide resistance to prevailing conditions such as withstand corrosion, high temperature or high pressure including conditions of environment to transfer the heated material for any use. The said high pressurised material outlet pipe can have a reducing diameter so as to retain pressure.

### Detailed Description of the Valves (One Directional Control Valves and One Directional Force Control Valves), Actuator

1. The inventions is novel in that valves permitting gases, liquids or other material to flow in one direction only and open and close independently or may be triggered or controlled by a mechanism or control devices such as an actuator or may be remotely controlled to open and close. When two or more of the said valves are placed consecutively in a pipe, chamber or energy harnessing chamber, and when two valves are closed to create a chamber in the space between, then the first closed valve becomes the inlet valve and the second closed valve becomes the outlet valve of the chamber created. Hence if three or more valves are closed a series of chambers is created.
2. This invention has valves that may be located in a series and operate independently as well as in unison with each other. A mechanism or control devices such as an actuator can be added to a valve to assist a valve to open and close at a required setting. The valve is set to open and close when the temperature, pressure and/or volume of the material inside a pipe or chamber or energy harnessing chamber reaches a certain level. The valve thereby allows the input of material, controlling the flow and volume of material entering the chamber.
3. The valves control the flow, direction and volume of the material relying on the force of gravity or relying on pressure created by the heated material inside an energy harnessing chamber from thermal heat that is trapped by the energy harnessing chamber and thereby creating pressure; this negates the use of pumps. In the case of gases, original pressure from the reservoir or inlet would apply.
4. The valve controls the time that the material fills and stays inside any of the energy harnessing chambers for the material to be exposed to heat from thermal heat being transferred through the walls of each energy harnessing chamber. When the temperature and pressure inside an energy harnessing chamber reaches a predetermined level while retaining constant volume, the Outlet valve opens allowing the material to flow into the next chamber. This enables the volume of the material in both chambers to be equalised.
5. The valves will control the volume and pressure of material that enters or exits into each energy harnessing chamber or pipe depending on the setting of the valves or mechanisms or control devices such as actuators. This assists in the controlled build up of the temperature, pressure and volume within the energy harnessing chamber.
6. Temperature, volume and pressure are relative. If there is an increase in temperature, it has a direct impact on the pressure and volume. Any change to one of the three conditions would cause a change to any of the other two conditions. Consequently, change to any one of the three conditions while retaining one of the conditions constant would cause a change to the third condition. Therefore, if the temperature of the material that fills a chamber is raised inside a chamber while the volume remains constant there will be an increase in pressure proportionate to the temperature increase. This pressure enables the chamber to expel the heated material.
7. The temperature of the material in the chambers increases due to the supply of thermal heat that is conducted and transferred from the energy harnessing chamber walls to the material inside the chamber. This increase in temperature while retaining constant volume, causes an increase in the pressure of the material within the energy harnessing chamber to trigger the valve or mechanisms or control devices such as actuator of the valve to open and close. The valve opens allowing the heated material to leave the chamber in one direction with the aid of the increased pressure in the chamber. The valve or mechanisms or control devices such as actuators can open or close at the predetermined level of temperature, pressure and/or volume.
8. Once the material leaves the chamber, there is a reduction in the volume and pressure in that chamber, the valve or mechanisms or control devices such as actuator then shuts the outlet valve at the exit of that chamber. Then the inlet valve of that same chamber opens allowing new material to enter into that chamber. The supply of heat to that chamber while retaining the volume at an almost constant increases the temperature and pressure of the new material that entered that chamber until the exit valve opens again. This cycle continues relying on the heat from a reliable heat source. This process is repeated till the last energy harnessing chambers has reached approximately full pressure then the material would be able to be transmuted and expelled to a location.
9. This inventive step enables heat energy to be transferred to the material within the energy harnessing chamber until the material reaches a predetermined temperature and pressure level. This is a novel means to harness and transfer heat energy and energy to a location without the need for pumps and conventional means.
10. The invention is novel in that it can have valves, or mechanisms or control devices such as actuators set to operate the valves such that when the maximum predetermined level of temperature has been transferred to the material inside the energy harnessing chambers while retaining constant volume, the valves would open to move the heated pressurised material to the next chamber or to exit through the return outlet pipe/chamber.
11. Once the pressure ascends to the maximum required level due to the ascending temperature, the valve acting as outlet to the energy harnessing chamber opens. This build up of pressure enables material to exit and to enter the next energy harnessing chamber. The material in the next energy harnessing chamber is subjected to a similar control mechanism and process as was in the earlier chamber; namely the setting for the material in the next energy harnessing chamber is at a slightly lower valve or actuator setting to that of the previous energy harnessing chamber. The same cycle is repeated up to the last energy harnessing chamber so that there is a controlled build up of thermal energy from a reliable heat source.
12. The novelty of the invention is in the ability of the energy harnessing chamber to create and retain pressure, volume and temperature at predetermined specifiable levels assisted by valves that may be triggered or controlled by a mechanisms or control devices such as actuators. There is a gradual decrease in the setting of the valves, or mechanisms or control devices such as actuators from chamber to chamber. The first chamber is therefore set at the highest required threshold, slightly decreasing in each inter-mediate chamber whilst the last chamber has the valve, or mechanisms or control devices such as actuators set at the lowest required threshold. This enables the heat from a reliable heat sources to increase the temperature and pressure and to transmute and expel the heated material to a location without the need to rely on conventional means such as the use pumps or other existing methods.

1. Systems, which can consist of devices comprising of a reservoir, reservoir outlet, inlet pipe/chamber, valves permitting flow in one direction only which can include one directional control valves or one directional force control valves where the valves may be stroked by a mechanism or control device such as an actuator, chamber(s) including energy harnessing chamber(s), and can include return outlet pipe/chamber, return pressurised outlet pipe/chamber and high pressurised material outlet pipe, when connected in a combination of these devices to each other, harness, extract, transmute, exchange and transfer heat from a heat source through strategic placement and use of the said valves and the said energy harnessing chambers;
means of conveying gases, liquids, heated material or any other material through the said inlet pipe/chamber to and from any location to the energy harnessing chamber(s) to be subjected to heating, whereby the valves in the pipes and the chambers that are interconnected can control pressure, volume, direction, duration, temperature and flow of material where a series of the valves allow and control entry or exit of gases, liquids, heated material or any other material;
the said valves placed at intervals in the pipe or the chamber can open and close allowing control of entry and exit of the said material to and from a pipe or chamber thus enabling the valve to act as a controlling device allowing the material to be moved into the adjoining pipe or chamber; and
devices wherein the said energy harnessing chamber being configured to conducts heat, allows heat from a reliable heat source to be conducted and transferred to any material within the energy harnessing chamber enabling it to control, transmute, increase and retain volume, temperature, pressure, direction, duration and flow of the material within the energy harnessing chamber at specifiable levels so that sufficient temperature and pressure is created to expel the material within the energy harnessing chamber without a need to rely on the use of pumps.

2. The devices as defined in claim 1 where two or more of the said valves placed consecutively in the said pipe or chamber and when two valves are closed to create a chamber in the space between, the first closed valve becomes the inlet valve and the second closed valve becomes the outlet valve of the chamber created. Hence if more than two valves are closed they will create a series of chambers, where the outlet valve becomes the inlet valve for the next or succeeding pipe or chamber.

3. The devices as defined in claim 1 wherein the gas, liquids or any other material travels through the inlet pipe/chamber and enters the said energy harnessing chambers through the inlet valve and fills the (first) energy harnessing chamber; the gas, liquids or any other material begins to increased temperature and pressure from heat energy that is been conducted, extracted and transmuted from a reliable heat source through the walls of the (first) energy harnessing chamber, the supply of heat increases the temperature and pressure while retaining constant volume of the material that entered the (first) energy harnessing chamber, the outlet valve opens when a predetermined temperature and/or pressure level is reached. The heated material leaves the (first) energy harnessing chamber when the outlet valve opens and enters the succeeding (second) energy harnessing chamber where the outlet valve of the (first) energy harnessing chamber shuts and the inlet valve of the (first) energy harnessing chamber opens allowing new material to enter and refill the (first) energy harnessing chamber; this process can be repeated to maximum increase the heat energy level required to be conducted through the first or subsequent energy harnessing chamber(s) that can be interconnected so by the time the material is about to leave any or the last of the energy harnessing chambers, it has sufficiently transmuted and harnessed the surrounding heat energy.

4. The devices as defined in claim 1 wherein the inlet pipe/chamber connects and conveys gases, liquids, heated material or other material to the said energy harnessing chamber; the inlet pipe/chamber can be insulated and made of suitable material capable to convey gases, liquids, heated material or any other material for the safe passage thereof.

5. The devices as defined in claim 1 wherein the said energy harnessing chamber(s) can be made of suitable material capable of conveying gases, liquids, heated material or any other material through each chamber that can conduct heat and can provide resistance to prevailing conditions.

6. The devices as defined in claim 1 wherein the said energy harnessing chamber system can have the energy harnessing chamber which can be of any shape that allows for the transition of gases, liquids or other material to flow and channel the material through to and out the outlet valve of the chamber.

7. The devices as defined in claim 1 wherein the said energy harnessing chamber system can have one or more energy harnessing chamber(s) in the system connected in series or any parallel or any series and parallels combination.

8. The devices as defined in claim 1 wherein the said return outlet pipe/chamber system can have the said valves creating individual return outlet pressurised pipe/chamber(s) within the return outlet pipe chamber system which can be insulated, can be connected to the last energy harnessing chamber providing passage to transfer heated materials in a controlled manner and can be made of suitable material capable to provide resistance to any prevailing conditions.

9. The devices as defined in claim 1 wherein the said high pressurised material outlet pipe can be connected at the end of the return outlet pipe/chamber or the last of the energy harnessing chamber(s) to transfer the heated material for any use; the said high pressurised material outlet pipe can have a reducing diameter so as to retain pressure, can be insulated and can be made of suitable material capable to provide resistance to any prevailing conditions. One or more high pressurised material outlet pipe(s) can be used in the energy harnessing chamber system.

10. The devices as defined in claim 1 can be made of suitable material which can be watertight, withstand corrosion, be flood-proof and provide resistance to any prevailing conditions capable to convey gases, liquids, heated material or any other material.

11. The devices as defined in claim 1 wherein the said gases, liquids, heated material or any other material may, after their usage, be recirculated and recycled back to the energy harnessing chamber system(s).
